(19) United States
(12) Patent Application Publication
(10) Pub. No.: US 2026/0048941 A1
(43) Pub. Date: Feb. 19, 2026

(54) SYSTEM FOR PREPARING ORDERS FOR PRODUCTS STORED IN A MULTI-LEVEL WAREHOUSE AND PICKED BY A PLURALITY OF AUTONOMOUS MOBILE ROBOTS

(71) Applicant: IFOLLOW, Arcueil (FR)

(72) Inventors: Nicolas Menigoz, PARIS (FR); Vincent Jacquemart, MEUDON (FR)

(21) Appl. No.: 19/101,749

(22) PCT Filed: Aug. 3, 2023
(86) PCT No.: PCT/EP2023/071506

§ 371 Date: Feb. 6, 2025

(30) Foreign Application Priority Data
Aug. 9, 2022 (FR) FR2208210

(51) Int. Cl. B65G 1/137; B65G 1/06

(52) U.S. Cl. CPC B65G 1/1378; B65G 1/065

(57) ABSTRACT

A system for preparing orders for products stored in a logistics warehouse. The system includes: a products-storage store including plural stories, each story having a shelf unit having levels subdivided into storage locations; autonomous mobile picking robots, capable of moving around in at least one circulation zone of each story, the picking robots ensuring picking of products inside the storage locations of a given level of a shelf unit, each picking robot able to stow a picked product on a storage support of the picking robot while the robot moves around on the ground; a lift able to move a picking robot from one story of the products-storage store to another; an order preparation zone distant from the products-storage store towards which the picking robots convey picked products, the order preparation zone including a workstation for making up the order from the products conveyed by the picking robots.

### FIELD OF THE INVENTION

The field of the invention is that of logistics, and in particular that of systems for preparing orders within a logistics warehouse for products to be shipped.

The present invention relates in particular to assistance for preparing orders by means of Autonomous Mobile robots (AMR).

### Prior Art

Automated systems for preparing orders are more particularly used in companies selling small volume products (tools, spare parts, electronic products, etc.) remotely.

These systems make it possible to prepare with a minimum of labour, in a short time and with precise stock monitoring, a package corresponding to a specific order from a customer, said order concerning one or more products in various quantities.

These systems generally consist of:
a products-storage store comprising shelf units separated by circulation aisles with a plurality of superimposed storage levels containing the products (articles) able to be picked or deposited;
at least one order preparation workstation, where the products are picked and placed by an operator (or a robot) in a shipping package or on a support (a pallet for example);
means for conveying products stored in the products-storage store to the order preparation workstation, and vice versa; and
a control (or central management) system.

The logistics field has developed continuously for many years. Thus, motorised mobile robots referred to as autonomous robots are today commonly used as transporters in these order preparation systems. These robots can cooperate with operators in the same workspace in order to optimally prepare the various orders that are received by the warehouse order management system. These robots make it possible to reduce the arduousness of the work of operators by carrying the loads for them. As robots are able to carry heavier and/or bulkier loads than humans, they reduce the distances that operators have to travel. Robots make it possible for operators to carry out value-added tasks by freeing the hands thereof, for example operating a tablet to interact with an order management and inventory management system.

Thus, a plurality of picking techniques are known involving the cooperation of picking operators and robots.

According to a first approach, relatively simple approach, an operator is responsible for picking the various products of an order from various locations in the warehouse and depositing them on the autonomous robot that accompanies them. A major drawback of this first approach is that the travel times of the robot and of the operator are relatively long, which results in very low efficiency of the operator and of the robot respectively. Indeed, the efficiency can be determined based on the hourly picking rate, that is to say the number of pickings made per hour.

According to a second approach, the warehouse is divided into a plurality of regions and a picking operator is assigned to each of these regions. Thus, for each order, the autonomous robot travels through the various regions of the warehouse to collect the products manually picked by the operators.

Although this approach makes it possible to increase the efficiency of the picking operators by reducing the distance they have to travel between two pickings, the routes taken by the picking robots are relatively long and do not provide a satisfactory solution.

Moreover, a recurring problem in logistics is that the warehouse where the products-storage store is located may become too small, particularly due to the increase in sales and/or the listing of new products. To overcome this problem, it is common to increase the surface area of warehouses to extend the products-storage store for products to be picked. However, storage areas that are too large have the consequence of increasing the distances to be covered between two pickings.

Furthermore, the strong demand for storage surface area in recent years has caused land prices to rise. In order to overcome this drawback, the current trend is to increase the height of warehouses and therefore of storage shelf units.

To pick products from these high shelf units, robots have been developed capable of moving along the shelf units to pick a product at height and on the ground to then convey it to a specific order preparation workstation. The large number of robots required to implement this solution (each robot picking and transporting a single product) creates problems with the circulation of robots on the ground since they intersect to each go towards a specific order preparation workstation.

Alternatively, robots have been developed that move only on the ground and are equipped with a mast for picking a product from a shelf unit, the mast having a height between 8 and 12 m. Such a mast height does not make it possible for the robot to move quickly.

None of the known prior art solutions therefore makes it possible to respond in a fully satisfactory manner to the increasingly high rates that are required today, while taking into account the surface area constraints of warehouses.

Therefore, there is a need to provide a novel approach that can adapt to these various constraints while optimising the overall efficiency of the system, that is to say the efficiency of operators and of robots.

### SUMMARY OF THE INVENTION

The present technique meets this need by proposing a system for preparing orders for products stored in a logistics warehouse comprising:
a products-storage store comprising a plurality of stories, each story having at least one shelf unit having a plurality of levels subdivided into storage locations;
a plurality of autonomous mobile robots, referred to as picking robots, capable of moving around in at least one circulation zone of each story of the products-storage store, said picking robots ensuring the picking of products inside the storage locations of a given level of a shelf unit, each picking robot comprising means for moving around on the ground, means for picking products inside the storage locations and means for stowing the products picked from a plurality of superimposed storage supports of the picking robot, each picking robot further comprising a vertical mast on one side of which the superimposed storage supports are mounted, the pricking means and the stowage means being mounted on the other side of the mast, and the stowage means being capable of stowing a picked product on one of the storage supports of the picking robot while the robot is moving around on the ground;
at least one lift able to move at least one of said picking robots from one story of the products-storage store to another;
at least one order preparation zone distant from the products-storage store towards which said picking robots convey picked products, said order preparation zone comprising at least one order preparation workstation for making up the order from products conveyed by said picking robots.

Thus, the present technique proposes a novel and inventive solution for preparing orders implemented by picking operators and by a fleet of autonomous mobile robots in a warehouse storing products to be shipped, making it possible to significantly increase the order preparation productivity without requiring too much surface area on the ground.

To do this, on the one hand, the products-storage store has a plurality of superimposed storage stories that can reach 40 to 45 m high for example, which makes it possible to multiply the available storage surface area, and on the other hand, the picking of products on each of the stories of the warehouse is carried out by picking robots provided with mobile picking means at height for picking products from the various levels of the shelf units. These picking robots can move around from one story to another in the products-storage store by means of lifts for picking a plurality of products and storing them until they are conveyed towards an order preparation zone.

Rather than increasing the height of the products-storage shelf units, which would require the picking robots to be able to pick products from very great heights, it is proposed to stack stories vertically (4, 8 or 12 stories for example) in the warehouse, each story having at least one circulation zone for at least one picking robot and at least one shelf unit having a plurality of levels subdivided into storage locations.

Due to the fact that the storage warehouse has a plurality of stories, the picking mast of the mobile picking robots remains at a reasonable height, which ensures good stability and speed of movement of the robots on the ground. The robots can move around each story of the store completely autonomously, which does not require the expensive and inflexible installation of rails or guide strips on the ground or the shelf units of each story.

Such a multi-level warehouse makes it possible to multiply the storage space in a single warehouse, which ensures space savings (and resolves the problem of land costs), and makes it possible to centralise the logistics activity on a single site rather than on a plurality of remote sites. Consequently, this warehouse configuration can be close to cities and the end consumer.

This solution also makes it possible to improve the order preparation efficiency, in particular by reducing the movements of operators and of autonomous mobile robots, as well as by optimising each step of the logistics chain.

In addition, the picking robots of the system of the invention are designed to be able to stow a picked product in one of the storage supports thereof even during the movements thereof, for example towards an order preparation zone. This feature is particularly innovative, because conventional robots, when loaded with products that they have picked from a shelf unit in a warehouse, are not very stable when in motion and the picked products can very easily tip over and fall to the ground during the movement thereof.

According to a particular aspect of the invention, the height of the mast is less than or equal to 4 m.

According to a particular aspect of the invention, each order preparation workstation is associated with an exchanger capable of cooperating with a picking robot and comprising first means for transferring products stowed on the storage supports from said picking robot towards a first buffer module of the exchanger and then towards the order preparation workstation.

According to a particular aspect of the invention, the first buffer module comprises means for scheduling the transferred products before the transfer thereof towards the order preparation workstation.

According to a particular aspect of the invention, said exchanger comprises second means for transferring products coming from the order preparation workstation towards a second buffer module and then towards the storage supports of said picking robot.

According to a particular aspect of the invention, the height of the products-storage store is between 40 and 80 m.

The invention relates to a picking robot intended to be implemented in a system as described previously.

### LIST OF THE FIGURES

The proposed technique, as well as the various advantages that it has, will be more easily understood, in light of the following description of an illustrative and non-limiting embodiment thereof, and from the appended drawings, wherein:

FIG. 1 illustrates a warehouse for storing products to be shipped from an order preparation system in accordance with the invention, comprising a multi-level products-storage store, an order preparation zone and a plurality of mobile robots for collecting products stored in the products-storage store;

FIG. 2 is a detail view of the products-storage zone of the warehouse of FIG. 1 showing in particular a lift for moving a picking robot from one story to another of the products-storage store;

FIG. 3 shows an island of an order preparation zone of an order preparation system in accordance with the invention, wherein a picking robot cooperates with an exchanger of an order preparation workstation.

### DETAILED DESCRIPTION OF THE INVENTION

The present technique proposes a novel and inventive solution for preparing orders implemented by operators and by a fleet of autonomous mobile robots in a warehouse storing products to be shipped, making it possible to significantly increase the order preparation productivity without requiring too much surface area on the ground.

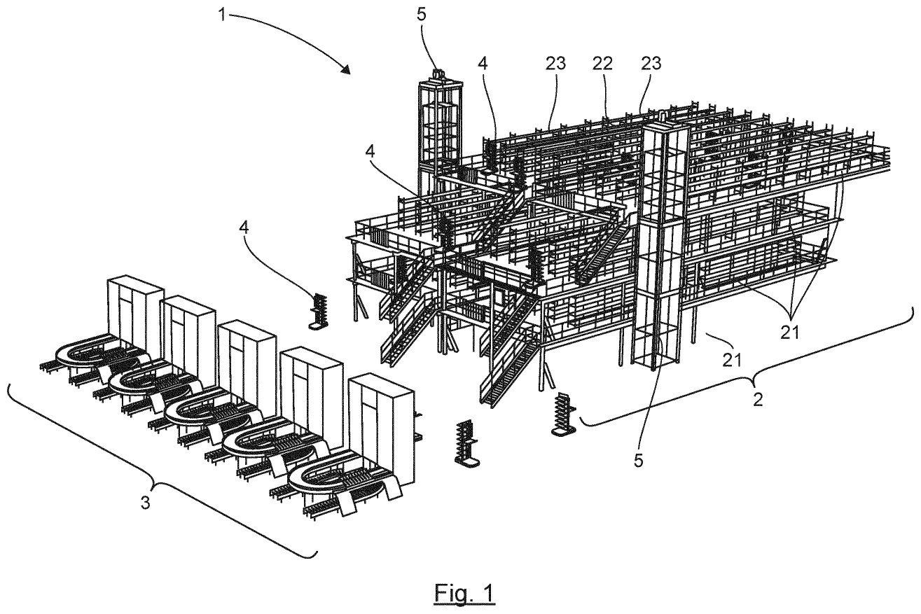

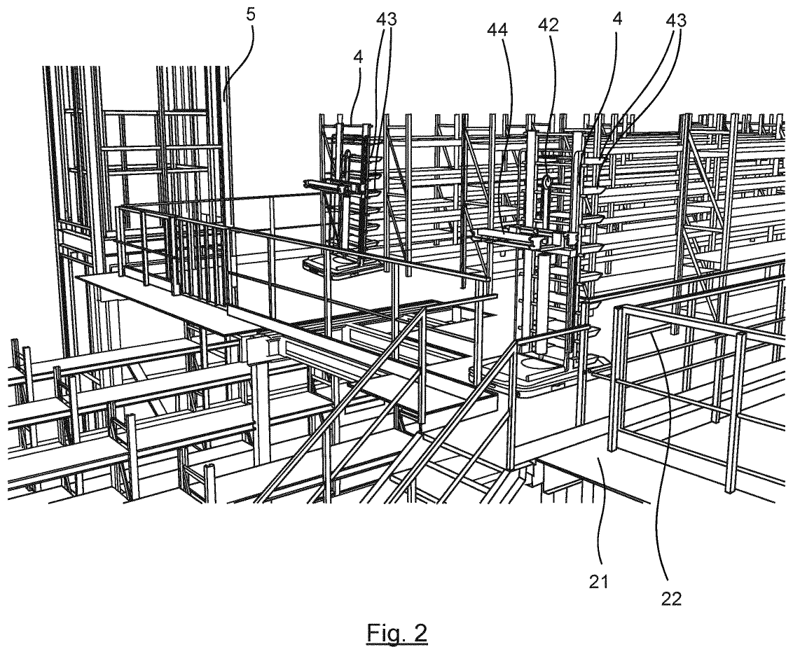

The storage warehouse 1 comprises a products-storage store, or storage zone, 2 which comprises in the configuration illustrated in FIGS. 1 and 2 four storage stories 21, each storage story 21 comprising a floor on which are defined a plurality of circulation aisles 22 serving on either side a storage shelf unit 23 (or racking) with a plurality of superimposed storage levels, each storage shelf unit 23 being subdivided along its length into storage locations (not visible in the figures) intended to each accommodate a container 25 of products (a container may be a tray with a plurality of products or articles inside or a package comprising a single product or article).

The products-storage store 2 here extends over several tens of square metres and has a height of 45 m. The number of stories and the height of the products-storage store may be greater than in the example described here.

Each circulation aisle 22 of a story is sized to make it possible to move motorised mobile units taking the form of picking robots 4 that ensure the movement of the containers 25 of products, for the placement thereof inside the storage locations and for the picking thereof from these storage locations. The mobile robots 4 can not only move horizontally at a given storage story 21, but can also be conveyed from one storage story 21 to another, whether or not they are transporting products, by lifts 5 (also called lifts/descenders). As illustrated in the implementation example of FIG. 1, a lift 5 is installed on each side of the products-storage store 2.

However, the number of lifts is not limited to the example described here.

In this multi-level storage warehouse 1, in addition to the ground floor, a plurality of mezzanines is therefore planned, installed at height and resting on the warehouse slab, each mezzanine forming a story of the products-storage store 2.

Moreover, the system comprises, on the ground floor of the storage warehouse 1, an order reconstitution or preparation zone 3 that makes it possible to reconstitute orders from the products collected/picked by one or more picking robots. Once all of the products have been collected by a picking robot 4, the latter heads towards the order reconstitution zone 3 in order to deposit therein the picked products in the products-storage store 2.

This order reconstitution zone 3 here comprises a plurality of islands, each comprising an exchanger and a workstation for preparing orders by an operator.

Stairs make it possible for operators to move from the order preparation or reconstitution zone 3 towards each of the storage stories 21. An operator can thus come and find a tray or package from a shelf unit on one of the storage stories 21. Each of the autonomous mobile robots, referred to as picking robots, 4 of the system for preparing orders for products stored in the warehouse 1 is equipped with a chassis 41 extending horizontally and on which a central vertical mast 42 is mounted provided on one side with a plurality of superimposed storage supports 43 (nine storage supports in this example) for receiving the containers 25 of products, and to make it possible to prepare different orders (which increases the order preparation efficiency). The central mast 42 is provided on the other side with a mobile picking platform or trolley 44 capable of moving vertically along the central mast 42 and which ensures the movement of the product containers 25, for the placement thereof inside the storage locations and for the picking thereof from these storage locations.

The picking robot 4 further comprises means for transferring a container 25 picked by the picking platform 44 towards one of the storage supports 43 of said robot (and vice versa, a container 25 disposed on a storage support 43 of the robot towards the picking platform 44 so that the latter (re)places said container 25 inside a storage location).

The central mast 42 with a maximum height of 4 m makes it possible to carry a plurality of containers (nine in this example) on the storage supports instead of only one as in the prior art. The speed of movement of each picking robot 4 equipped with such a central mast 42 is further greater than that of the robots of the prior art equipped with masts of greater height (8 to 12 m).

Advantageously, the means for transferring a picking robot 4 are capable of stowing a container picked by the picking platform 44 on one of the storage supports of the picking robot 4 (or vice versa) while the picking robot 4 is moving around on the ground, which makes it possible to save time.

The picking robot 4 further comprises an electric drive system using a battery(ies) rotating wheels (four in number for example) located under the chassis 41 that make it possible to stabilise and move the robot. The mobile loading platform 44 can be moved vertically and has an electric drive for this axis of movement that can be supplied with electrical energy coming from said at least one storage battery. The height position of the mobile loading platform 44 can thus be modified between a low position, a high position, and one or more intermediate positions.

Moreover, the picking robot is equipped in the example described with a reading module (scan) capable of reading a bar code affixed to each of the product containers 25 in the products-storage store 2 and consisting of an identifier of an article or product of a given order to be prepared.

The picking robots 4 intervene in the order preparation process by operating completely autonomously between various zones of the multi-level storage warehouse 1 and by taking charge of the preparation of one (or more) order(s) by following an optimised route.

To do this, one or more autonomous robots (five for example) can be assigned to each storage story 21 of the products-storage store 2.

Once a set of containers (packages and/or product bases) has been collected by a picking robot 4, the latter heads towards the order reconstitution zone 3 in order to deposit therein the containers picked from the products-storage store 2.

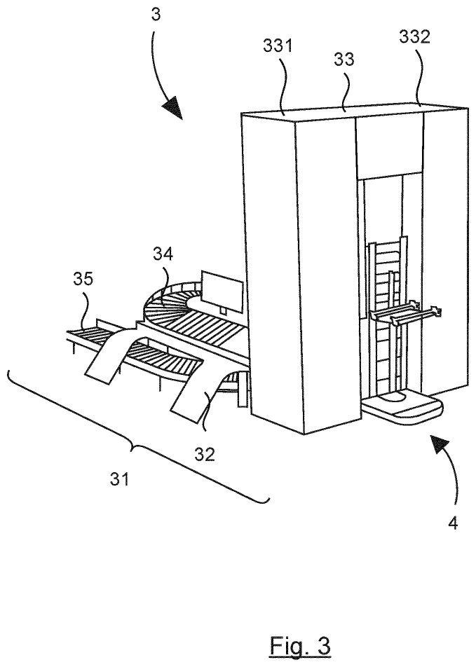

FIG. 3 shows an island 31 of the order reconstitution or preparation zone 3 that makes it possible to reconstitute orders from the containers 25 collected/picked by one or more picking robots.

This island 31 comprises an order preparation workstation 32 that is associated with an exchanger 33 capable of cooperating with a picking robot 4. The picking robot 4 having picked a set of product containers 25 is housed in a central compartment of the exchanger 33, the latter comprising first means for transferring the containers 25 stowed on the storage supports 43 of the picking robot 4 towards a first buffer module 331 of the exchanger 33, means for scheduling these containers and for depositing these containers on an upper conveyor 34 at the order preparation workstation 32. If the container is a package of an order to be prepared, an operator moves the latter from the upper conveyor 34 towards a lower conveyor 35. If this concerns a tray of products, it picks one or more products of an order to be prepared in the tray and places them on a lower conveyor 35, the tray remaining on the upper conveyor 34 to be directed towards a second buffer module 332 of the exchanger 33. The exchanger 33 comprises second means for transferring trays of products coming from the upper conveyor 34 towards the second buffer module 332, then towards the empty storage supports of the picking robot 4 located in the exchanger 33.

Thus, a picking robot 4 brings a plurality of trays of products and/or packages (called containers) to an exchanger 33 that will automatically pick the trays and/or packages then organise them optimally for operator picking and finally shipping of the order.

In the example described, a plurality of robots (five for example) work simultaneously to supply an exchanger, and therefore an operator.

The buffer modules 331, 332 of an exchanger 33 are in the form of columns wherebetween a picking robot loaded with a plurality of trays and/or packages is placed. The exchanger by means of a gripping device (called a comb) moves the containers (nine in the illustrated example) of the robot laterally into the first buffer module 331 wherein scheduling of the containers is implemented. The containers are then distributed on the upper conveyor 34 so that an operator picks a product from each container which they then place in a customer package located below on a lower conveyor 35. The trays are then directed by the upper conveyor 34 towards the second buffer module 332 where they are received then transferred towards the picking robot, to be transported and deposited by the latter on the shelf units of the products-storage store.

The proposed technique further provides for generating and transmitting movement orders (or tasks) to each of the picking robots so that the latter collect each of the products of at least part of at least one order.

At the end of the collection of products by the various robots, the orders are subsequently reconstituted in order to be shipped in due course.

A central management system generates and transmits movement orders (or tasks) to each of the autonomous mobile picking robots so that the latter collect on one or more storage stories 21 each of the products of at least part of at least one order.

At the end of the collection of the products by the various picking robots, the orders are subsequently reconstituted in order to be shipped in due course.

By deploying the products-storage store 2 vertically, rather than horizontally, and by circulating autonomous mobile picking robots therewithin, the movements of the autonomous mobile picking robots within the warehouse for storing products to be shipped are optimised in order to maximise the use/efficiency thereof. By improving the efficiency of operators and of robots, a greater number of orders can be carried out per unit of time (per hour for example).

The proposed technique makes it possible to optimise the number of operators in the warehouse, the distance between two pickings, the daily weight per operator, the overall travel time of a fleet of robots and even the electrical energy used by the fleet of robots.

Autonomous mobile robots are suitable for preparing orders for products stored in the warehouse, that is to say they have specific features such as, in particular:
communication capabilities with other robots in the same fleet and with a supervision system responsible for managing a fleet of robots, with the aim of optimising the preparation of orders in the warehouse;
ease of movement in the warehouse aisles, wherein other robots circulate;
energy autonomy to be able to prepare the greatest number of orders without having to be recharged;
compactness and in particular low thickness, for example to be able to slide under elements to be transported.

Each robot comprises at least one camera and/or radar and/or lidar type sensors making it possible to autonomously move the robot, that is to say without an external guidance device.

The central warehouse management system (WMS), internal and specific to the warehouse wherein the proposed technical solution is implemented, provides a certain amount of data to the management system of the fleet of autonomous mobile robots for preparing orders. This warehouse management system (WMS) is well-known and widely used. It will therefore not be described further in this document.

The autonomous mobile robot fleet management system comprises various modules, namely:
a picking manager capable of receiving data coming from a warehouse management system and generating and transmitting warehouse management data;
an order manager capable of receiving at least the warehouse management data coming from the picking manager and of delivering order scheduling data;
a fleet manager capable of receiving order scheduling data coming from the order manager and of communicating movement orders to the plurality of picking robots.

Furthermore, each robot in the robot fleet comprises a task manager.

The management system corresponds to one or more physical on-site (in the warehouse or a dedicated space close to the warehouse), remote (at a server host for example) or digitalised (in the “cloud”) servers.

This robot fleet management system is also well-known and widely used. It will therefore not be described further in this document.

The robots are equipped with means of two-way communication between them in order to coordinate the respective movements thereof and to know the progress of the preparation of orders respectively on one or more other robots. Indeed, the efficiency linked to the presence of a plurality of robots for a picking operator must not be limited by problems of robot movement (collisions in particular). The robot comprises one or more batteries for powering the electric motors as well as electronic systems for controlling these motors.

Finally, in order to compensate for any inaccuracies in the information communicated between the robots, particularly relating to the locations thereof or the respective speeds thereof, shape recognition means are implemented in the robots. In this way, the respective positioning of the robots is more precise and makes it possible to avoid collisions.

The process for preparing orders for products stored in the products-storage store comprises the following steps of:
picking, by a picking robot, a container 25 of products from a storage shelf unit 23 and transferring the container to a storage support of the robot;
moving the picking robot up to an order reconstitution and/or shipping zone;
transferring the containers of the storage supports from the robot towards a picking workstation;
picking, by an operator, at least one product for at least one order in said container 25 to reconstitute and ship an order;
transferring containers if they are not empty from the picking workstation towards the storage supports of the robot;
moving the robot to the storage shelf units to put back the non-empty containers.

1. A system for preparing orders for products stored in a logistics warehouse, the system comprising:
a products-storage store comprising a plurality of stories, each story having at least one shelf unit having a plurality of levels subdivided into storage locations;
a plurality of autonomous mobile robots, referred to as picking robots, capable of moving in at least one circulation zone of each story of the products-storage store, said picking robots ensuring picking of products inside the storage locations of a given level of a shelf unit, each picking robot being movable around on the ground, a picker for picking products inside the storage locations and a stow for stowing the picked products on a plurality of superimposed storage supports of said picking robot, each picking robot further comprising a vertical mast on one side of which the superimposed storage supports are mounted, the picker and the stow being mounted on the other side of said mast, and said stow being capable of stowing a picked product on one of said storage supports while said picking robot is moving around on the ground;
at least one lift able to move at least one of said picking robots from one story of the products-storage store to another; and
at least one order preparation zone distant from the products-storage store towards which said picking robots convey picked products, said order preparation zone comprising at least one order preparation workstation for making up an order from the products conveyed by said picking robots.

2. The system according to claim 1, wherein a height of the mast is less than or equal to 4 m.

3. A system according to claim 1, wherein each order preparation workstation is associated with an exchanger capable of cooperating with a picking robot and comprising first means for transferring products stowed on the storage supports from said picking robot towards a first buffer module of the exchanger and then towards the order preparation workstation.

4. The system according to claim 3, wherein the first buffer module comprises means for scheduling transferred products before the transfer thereof towards the order preparation workstation (32).

5. The system according to claim 3, wherein said exchanger comprises second means for transferring products coming from the order preparation workstation towards a second buffer module and then towards the storage supports of said picking robot.

6. The system according to claim 1, wherein a height of the products-storage store is between 40 m and 80 m.

7. A picking robot capable of moving in at least one circulation zone of each story of a products-storage store, said picking robot ensuring picking of products inside storage locations of a given level of a shelf unit, said picking robot comprising:
a drive system to move the picking robot around on a surface;
a picker for picking products inside the storage locations;
a plurality of superimposed storage supports;
a stow for stowing the picked products on the plurality of superimposed storage supports of said picking robot;
a vertical mast on one side of which the superimposed storage supports are mounted, the picker and the stow being mounted on the other side of said mast, and said stow being capable of stowing a picked product on one of said storage supports while said picking robot is moving around on the ground.
